(19) United States
(12) Patent Application Publication
(10) Pub. No.: US 2017/0364098 A1
(43) Pub. Date: Dec. 21, 2017

(54) METHOD FOR CONTROLLING AIR CONTROL VALVE

(71) Applicant: HYUNDAI MOTOR COMPANY, SEOUL (KR)

(72) Inventors: JONG GU KIM, SUWON-SI (KR); SUNG HAK LEE, SUWON-SI (KR)

(73) Assignee: HYUNDAI MOTOR COMPANY, SEOUL (KR)

(21) Appl. No.: 15/370,260

(22) Filed: Dec. 6, 2016

(30) Foreign Application Priority Data
Jun. 20, 2016 (KR) 10-2016-0076780

(51) Int. Cl. G05D 7/06; F01N 3/021; F01N 9/00

(52) U.S. Cl. CPC G05D 7/0635; F01N 9/002; F01N 3/021; F01N 2900/1602

(57) ABSTRACT

A method of controlling an ACV to increase a rate of temperature increase of exhaust gas and prevent excessive oil consumption may include a closing step of closing the ACV using a controller when regeneration of an exhaust gas after-treatment device is required, and an adjusting step of opening or closing the ACV using the controller in accordance with whether the pressure in an intake manifold is positive pressure or negative pressure.

### CROSS REFERENCE TO RELATED APPLICATION

The present application claims priority to Korean Patent Application No. 10-2016-0076780, filed Jun. 20, 2016, the entire contents of which is incorporated herein for all purposes by this reference.

### BACKGROUND OF THE INVENTION

### Field of the Invention

The present invention relates to a method for controlling an ACV (Air Control Valve) to increase a rate of temperature increase of exhaust gas and prevent excessive oil consumption.

### Description of Related Art

The temperature of exhaust gas should reach a predetermined level for DPF regeneration, and thus it is required to reduce the amount of newly inflowing air in order to quickly increase the temperature of the exhaust gas.

When the fuel-air ratio is increased by closing an ACV to minimize the amount of new air that flows in, the temperature of exhaust gas can be rapidly increased due to the increase in the amount of burned fuel.

Such an ACV (Air Control Valve) is open while a vehicle is normally driven, so the pressure in an intake manifold and a combustion chamber is maintained in a positive state.

However, when the ACV is closed to regenerate a DPF, negative pressure is generated in the intake manifold and the combustion chamber.

That is, pressure is generated in the opposite direction to the direction in which a piston ring scrapes oil in the combustion chamber, so the amount of oil that is exposed and remains in the combustion chamber increases, and thus oil consumption is increased.

The information disclosed in this Background of the Invention section is only for enhancement of understanding of the general background of the invention and should not be taken as an acknowledgement or any form of suggestion that this information forms the prior art already known to a person skilled in the art.

### BRIEF SUMMARY

Various aspects of the present invention are directed to providing a method of controlling an ACV to increase the rate of temperature increase of exhaust gas and prevent excessive oil consumption.

Various aspects of the present invention are directed to providing a method of controlling an ACV (Air Control Valve), the method including: a closing step of closing the ACV using a controller when regeneration of an exhaust gas after-treatment device is required; and an adjusting step of opening or closing the ACV using the controller in accordance with whether the pressure in an intake manifold is positive or negative.

The adjusting step may include a closing adjustment step of closing the ACV by a predetermined amount when the pressure in the intake manifold is positive.

The adjusting step may include: a negative pressure determination step of comparing the pressure in the intake manifold with reference pressure when the pressure in the intake manifold is negative pressure; and opening the ACV by a predetermined amount when the pressure in the intake manifold is the reference pressure or less as the result of the negative pressure determination step.

The method may further include a closing adjustment step of closing the ACV by a predetermined amount when the pressure in the intake manifold is found to be higher than the reference pressure as the result of the negative pressure determination step.

The method may further include a fully-opening step of fully opening the ACV when the temperature at the front end of an exhaust gas after-treatment device is higher than a reference temperature, after the adjusting step.

The pressure in the intake manifold may be detected by an Air Mass Flow (AMF) sensor.

According to the present invention, the ACV is closed or opened in accordance with the pressure state of the intake manifold, whereby the rate of temperature increase of exhaust gas for DPF regeneration is increased and the amount of oil remaining in a combustion chamber is reduced. Accordingly, excessive oil consumption is prevented.

The methods and apparatuses of the present invention have other features and advantages which will be apparent from or are set forth in more detail in the accompanying drawings, which are incorporated herein, and the following Detailed Description, which together serve to explain certain principles of the present invention.

### BRIEF DESCRIPTION OF THE DRAWINGS

FIG. 1 is a flowchart illustrating a process of controlling an ACV according to an exemplary embodiment of the present invention; and

FIG. 2 is a diagram showing the configuration of a system for controlling an ACV according to an exemplary embodiment of the present invention.

It should be understood that the appended drawings are not necessarily to scale, presenting a somewhat simplified representation of various features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DETAILED DESCRIPTION

Reference will now be made in detail to various embodiments of the present invention(s), examples of which are illustrated in the accompanying drawings and described below. While the invention(s) will be described in conjunction with exemplary embodiments, it will be understood that the present description is not intended to limit the invention(s) to those exemplary embodiments. On the contrary, the invention(s) is/are intended to cover not only the exemplary embodiments, but also various alternatives, modifications, equivalents and other embodiments, which may be included within the spirit and scope of the invention as defined by the appended claims.

Exemplary embodiments of the present invention will be described hereafter in detail with reference to the accompanying drawings.

A method of controlling an ACV of the present invention may include a closing step and an adjusting step.

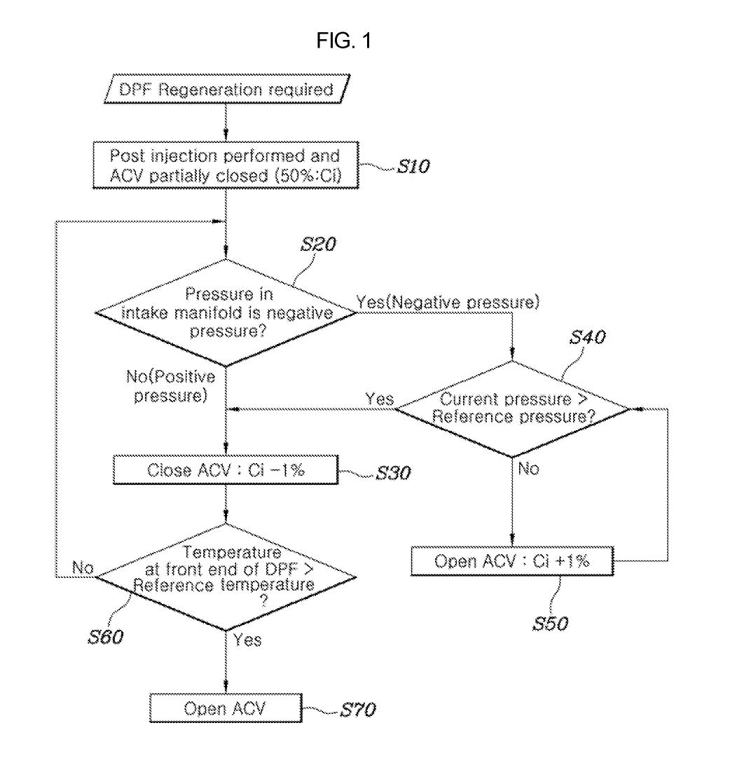

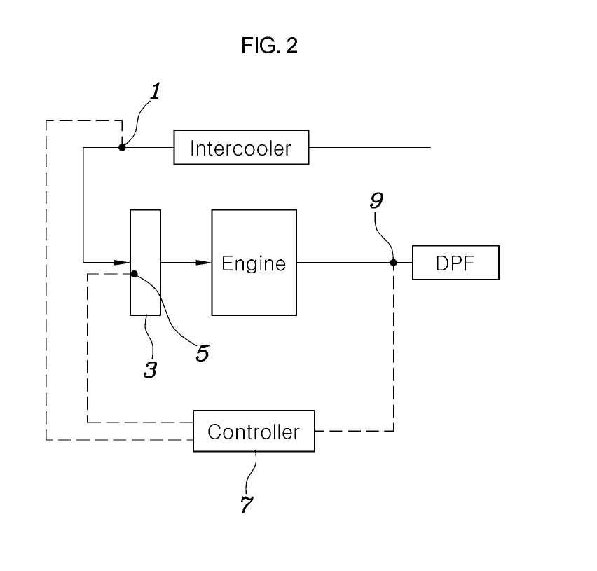

Referring to FIGS. 1 and 2, in detail, the ACV (Air Control Valve) can be controlled to be partially closed by a controller 7 when regeneration of an exhaust gas after-treatment device is required in the closing step.

For example, the exhaust gas after-treatment device may be a Diesel Particulate Filter (DPF), and the ACV 1, which is open, is controlled to be partially closed in accordance with a predetermined degree of opening Ci when DPF regeneration is required. Further, post-injection control may be performed.

The predetermined degree of opening Ci of the ACV valve may be 40˜60%.

Further, in the adjusting step, the ACV 1 can be controlled to be opened or closed by the controller 7 in accordance with whether the pressure in the intake manifold 3 is positive or negative.

That is, the ACV 1 is disposed between an intercooler and the intake manifold 3 to adjust the inflowing amount of new air, and not only the fuel-air ratio but also the pressure in the intake manifold 3 depend on the degree of opening of the ACV 1.

Accordingly, when the pressure in the intake manifold 3 is positive, a small amount of oil remains and is exposed in a combustion chamber, so the rate of temperature increase of exhaust gas is increased by performing control to close the ACV 1.

Further, when the pressure in the intake manifold 3 is negative pressure, a relatively large amount of oil remains and is exposed in a combustion chamber, and thus an increase in oil consumption is prevented by performing control to open the ACV 1.

In detail, when the pressure in the intake manifold 3 is positive pressure, it is possible to close the ACV valve 1 by a predetermined amount.

For example, after the degree of opening of the ACV 1 is set to 50% in accordance with a requirement for DPF regeneration, when it is determined that the pressure in the intake manifold 3 is positive pressure, the ACV 1 is controlled to be closed by a predetermined amount (0.5˜10%). Accordingly, it is possible to rapidly increase the rate of temperature increase of exhaust gas without increasing oil consumption.

The pressure in the intake manifold 3 can be detected by a sensor that can measure and estimate pressure, preferably, an Air Mass Flow (AMF) sensor 5 disposed in the intake line.

That is, it is possible to obtain calibration data pertaining to temperature variation on the basis of the flow speed (flow rate) through the AMF sensor 5 and estimate and detect the pressure in the intake manifold 3 from the data.

Further, when the pressure in the intake manifold 3 is negative pressure, the pressure in the intake manifold 3 is compared with reference pressure, and then, when the pressure in the intake manifold is found to be the reference pressure or less as the result of the comparison, the ACV valve 1 may be opened by a predetermined amount.

The reference pressure may be negative pressure that may influence the amount of oil consumption and may be set differently depending on the engine.

For example, after the degree of opening of the ACV 1 is controlled to 50% in accordance with a requirement for DPF regeneration, when it is determined that the pressure in the intake manifold 3 is negative pressure, the current pressure is compared again with the reference pressure. As the result of the comparison, when the current pressure is lower than the reference pressure, the ACV 1 is opened by a predetermined amount (0.5˜10%). Accordingly, it is possible to prevent an increase in oil consumption.

However, when the pressure in the intake manifold 3 is found to be higher than the reference pressure as the result of comparing the pressure in the intake manifold 3 with the reference pressure, the ACV 1 may be closed by a predetermined amount.

That is, even if the pressure in the intake manifold 3 is negative pressure, when it is not at a level that influences oil consumption, the ACV 1 is closed by a predetermined amount (0.5˜10%). Accordingly, it is possible to rapidly increase the rate of temperature increase of exhaust gas without increasing oil consumption.

Further, the present invention may further include a fully opening step that fully opens the ACV 1 when the temperature at the front end of the exhaust gas after-treatment device is higher than reference temperature after the adjusting step.

The reference temperature may be the minimum temperature suitable for DPF regeneration and may be measured by a temperature sensor 9 at the front end of the DPF.

That is, when the temperature at the front end of the DPF is higher than the reference temperature, the ACV 1 is fully opened. However, when the temperature at the front end of the DPF is equal to or lower than the reference temperature, the degree of opening of the ACV 1 is controlled again in accordance with the pressure in the intake manifold 3.

The flow of control of the ACV 1 according to an exemplary embodiment of the present invention is described hereafter.

Referring to FIG. 1, when there is a requirement for DPF regeneration, post-injection control is performed, and the ACV 1, which has been open, is closed by 50% (S10).

Next, whether the pressure in the intake manifold 3 is positive pressure or negative pressure is determined (S20), and then, when the pressure is found to be positive pressure as the result of the determination, the ACV 1 is closed by 1%.

On the other hand, when it is found to be negative pressure as the result of the determination, the current pressure is compared with the reference pressure (S40).

As the result of the comparison, when the current pressure is found to be the reference pressure or less, the ACV valve 1 is opened by 1% (S50). On the other hand, when the current pressure is found to be higher than the reference pressure, the ACV valve 1 is closed by 1% (S30).

Next, whether the temperature at the front end of the DPF is higher than a reference temperature is determined (S60), and when the temperature is found to have increased higher than the reference temperature as the result of the determination, the ACV valve 1 is fully opened (S70).

On the other hand, when the temperature is found to be the reference temperature or less as the result of the determination, the process reverts to step S20, and the ACV 1 is controlled again.

As described above, according to an exemplary embodiment of the present invention, the ACV 1 is closed or opened in accordance with the pressure state of the intake manifold 3, whereby the rate of temperature increase of exhaust gas for DPF regeneration is increased and the amount of oil remaining in a combustion chamber is reduced. Accordingly, excessive oil consumption is prevented.

For convenience in explanation and accurate definition in the appended claims, the terms “upper”, “lower”, “inner”, “outer”, “up”, “down”, “upper”, “lower”, “upwards”, “downwards”, “front”, “rear”, “back”, “inside”, “outside”, “inwardly”, “outwardly”, “interior”, “exterior”, “inner”, “outer”, “forwards”, and “backwards” are used to describe features of the exemplary embodiments with reference to the positions of such features as displayed in the figures.

The foregoing descriptions of specific exemplary embodiments of the present invention have been presented for purposes of illustration and description. They are not intended to be exhaustive or to limit the invention to the precise forms disclosed, and obviously many modifications and variations are possible in light of the above teachings. The exemplary embodiments were chosen and described in order to explain certain principles of the invention and their practical application, to thereby enable others skilled in the art to make and utilize various exemplary embodiments of the present invention, as well as various alternatives and modifications thereof. It is intended that the scope of the invention be defined by the Claims appended hereto and their equivalents.

What is claimed is:

1. A method of controlling an ACV (Air Control Valve), the method comprising:
a closing step of closing the ACV using a controller when regeneration of an exhaust gas after-treatment device is required; and
an adjusting step of opening or closing the ACV using the controller in accordance with whether a pressure in an intake manifold is positive pressure or negative pressure.

2. The method of claim 1, wherein the adjusting step includes a closing adjustment step of closing the ACV by a predetermined amount when the pressure in the intake manifold is positive pressure.

3. The method of claim 1, wherein the adjusting step includes:
a negative pressure determination step of comparing the pressure in the intake manifold with a predetermined pressure when the pressure in the intake manifold is negative pressure; and
opening the ACV by a predetermined amount when the pressure in the intake manifold is found to be the predetermined pressure or less as a result of the negative pressure determination step.

4. The method of claim 3, further comprising a closing adjustment step of closing the ACV by a predetermined amount when the pressure in the intake manifold is found to be higher than the predetermined pressure as the result of the negative pressure determination step.

5. The method of claim 1, further comprising a fully-opening step of fully opening the ACV when a temperature at a front end of the exhaust gas after-treatment device is higher than a reference temperature after the adjusting step.

6. The method of claim 1, wherein the pressure in the intake manifold is detected by an Air Mass Flow (AMF) sensor.
